(19) United States
(12) Patent Application Publication
(10) Pub. No.: US 2013/0136636 A1
(43) Pub. Date: May 30, 2013

(54) BRUSHLESS MOTOR AND ELECTRIC PUMP

(71) Applicant: AISAN KOGYO KABUSHIKI KAISHA, Aichi-ken (JP)

(72) Inventor: Masaki Ikeya, Aichi-ken (JP)

(73) Assignee: AISAN KOGYO KABUSHIKI KAISHA, Aichi-ken (JP)

(21) Appl. No.: 13/683,574

(22) Filed: Nov. 21, 2012

(30) Foreign Application Priority Data
Nov. 24, 2011 (JP) 2011-256768

(51) Int. Cl. H02K 1/12; F04D 13/06

(52) U.S. Cl. CPC H02K 1/12; F04D 13/06
USPC 417/423.7; 310/216.113

(57) ABSTRACT

A brushless motor includes a rotor and a stator. The stator includes a first core and a second core opposing the first core, between which the rotor is disposed. Each of the first core and the second core includes U-phase teeth, V-phase teeth, and V-phase teeth, each of which is extending parallel to one another and having a tip end opposing the rotor. A tooth located at one end of the first core and a tooth located at another end of the second core are connected to one another by a first nonmagnetic member, and a tooth located at another end of the first core and a tooth located at one end of the second core are connected to one another by a second nonmagnetic member.

### CROSS-REFERENCE TO RELATED APPLICATION

This application claims priority to Japanese Patent Application No. 2011-256768 filed on Nov. 24, 2011, the contents of which are hereby incorporated by reference into the present application.

### TECHNICAL FIELD

The present teachings relate to a brushless motor and an electric pump.

### DESCRIPTION OF RELATED ART

With a brushless motor, magnetic attractive force is generated between each tooth of a stator and a rotor, and the rotor is rotated by the magnetic attractive force. In order to generate appropriate magnetic attractive force between each tooth and the rotor, each tooth must be appropriately positioned with respect to the rotor. Japanese Patent Application Publication No. 2002-291190 discloses a technique for disposing each tooth at an appropriate position with respect to a rotor. A brushless motor described in Japanese Patent Application Publication No. 2002-291190 comprises a curled core, wherein an insulating member is arranged on a side surface of each tooth of the core. When the curled core is bent and molded into an annular shape, the insulating members arranged on the side surfaces of the teeth abut each other and the teeth are positioned thereby. Accordingly, each tooth is appropriately positioned with respect to the rotor.

### BRIEF SUMMARY OF INVENTION

A direction of magnetic attractive force that is generated between the rotor and each tooth is approximately consistent with a radial direction of a rotor. Therefore, since the teeth are inclined with respect to the radial direction of the rotor when the motor has a flat cross section, bending moment acts on the teeth due to the magnetic attractive force (i.e., force in the radial direction) created between the teeth and the rotor. Since the bending moment acting on a tooth periodically varies with rotation of the rotor, bending vibration may be generated at the tooth. A technique described in Japanese Patent Application Publication No. 2002-291190 concerns a motor with a circular cross section and therefore fails to consider that a bending moment may act on teeth. As a result, the technique may be incapable of reducing bending vibration of teeth which is generated in a rotor with a flat cross section.

The present teachings provide a technique capable of suppressing generation of bending vibration on a tooth due to bending moment acting on the tooth.

A brushless motor disclosed in the present specification comprises a rotor and a stator disposed outside of the rotor. The stator comprises a first core and a second core opposing the first core, the rotor being disposed between the first core and the second core. Each of the first core and the second core comprises a U-phase tooth, a V-phase tooth, and a W-phase tooth, each of which is extending parallel to one another and having a tip end opposing the rotor. The brushless motor further comprises: a first nonmagnetic member connecting a tooth located at one end of the first core to a tooth located at another end of the second core, a phase of the tooth located at the one end of the first core being same as a phase of the tooth located at the other end of the second core; and a second nonmagnetic member connecting a tooth located at another end of the first core to a tooth located at one end of the second core, a phase of the tooth located at the other end of the first core being same as a phase of the tooth located at the one end of the second core.

Furthermore, the present specification discloses a novel electric pump which uses the brushless motor described above. In other words, the electric pump disclosed in the present specification comprises: the brushless motor described above; an impeller driven by the brushless motor; and a pump chamber accommodating the impeller, the impeller being capable of rotating in the pump chamber. Since the electric pump uses the brushless motor descried above, pump efficiency can be increased.

### BRIEF DESCRIPTION OF DRAWINGS

FIG. 1 is a schematic longitudinal sectional view of an electric pump according to a first embodiment;

FIG. 2 is a diagram showing a stator along line II-II in FIG. 1;

FIG. 3 is a diagram showing a first condition of magnetic attractive force generated during driving of a rotor;

FIG. 4 is a diagram showing a second condition of magnetic attractive force generated during driving of a rotor;

FIG. 5 is a diagram showing a third condition of magnetic attractive force generated during driving of a rotor;

FIG. 6 is a diagram explaining magnetic attractive force that acts on teeth located at both ends;

FIG. 7 is a schematic longitudinal sectional view of a motor of an electric pump according to a second embodiment;

FIG. 8 is a diagram viewing an area below a stator from a position indicated by a line VIII-VIII in FIG. 7;

FIG. 9 is a diagram showing a stator of an electric pump according to a modification;

FIG. 10 is a diagram showing a stator of an electric pump according to a modification; and

FIG. 11 is a diagram showing a stator of an electric pump according to a modification.

### DETAILED DESCRIPTION OF INVENTION

In a brushless motor disclosed herein: a tooth located at one end of the first core and a tooth located at another end of the second core are connected to each other by a first nonmagnetic member, a phase of the tooth located at the one end of the first core being same as a phase of the tooth located at the other end of the second core; and a tooth located at another end of the first core and a tooth located at one end of the second core are connected to each other by a second nonmagnetic member, a phase of the tooth located at the other end of the first core being same as a phase of the tooth located at the one end of the second core. Therefore, magnetic attractive force acting on one of two in-phase teeth can be canceled out by magnetic attractive force acting on the other tooth. As a result, bending force acting on the teeth is reduced and bending vibration of the teeth can be suppressed. Moreover, a central tooth among the three teeth can be disposed along a radial direction of the rotor. Therefore, generation of bending vibration at the central tooth can be suppressed.

The brushless motor described above may further comprise: a third nonmagnetic member connecting the tooth located at the one end of the first core to the tooth located at the one end of the second core; and a forth nonmagnetic member connecting the tooth located at the other end of the first core to the tooth located at the other end of the second core. According to such a configuration, since a relative positional variation of teeth located at both ends of each core is prevented, bending vibration can be further suppressed.

In the brushless motor described above, the first nonmagnetic member, the second nonmagnetic member, the third nonmagnetic member, and the forth nonmagnetic member may constitute one tubular member. In this case, each of the tip ends of the teeth of the first core and the second core may be connected to an outer surface of the tubular member, and an inner surface of the tubular member may oppose the outer surface of the rotor with an interval in between. According to such a configuration, assembly of the nonmagnetic members to each tooth can be readily performed.

In the brushless motor described above, the rotor may comprise a rotor shaft. In addition, each of the first nonmagnetic member and the second nonmagnetic member may comprise a supporting portion, the rotor shall being rotatably supported by the supporting portions. According to such a configuration, since the rotor shaft is rotatably supported by the first nonmagnetic member and the second nonmagnetic member, a member for supporting the rotor shaft need no longer be separately provided.

In the brushless motor described above, each of the third nonmagnetic member and the fourth nonmagnetic member may comprise a first portion provided on the tooth of the first core, and a second portion provided on the tooth of the second core. A first engaging portion may be formed in the first portion and a second engaging portion which engages the first engaging portion may be formed in the second portion. In addition, the teeth of the first core and the teeth of the second core may be connected to each other by engaging the first engaging portion with the second engaging portion. According to such a configuration, the first core and the second core can be accurately positioned.

Representative, non-limiting examples of the present teachings will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved brushless motor and electric pump, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

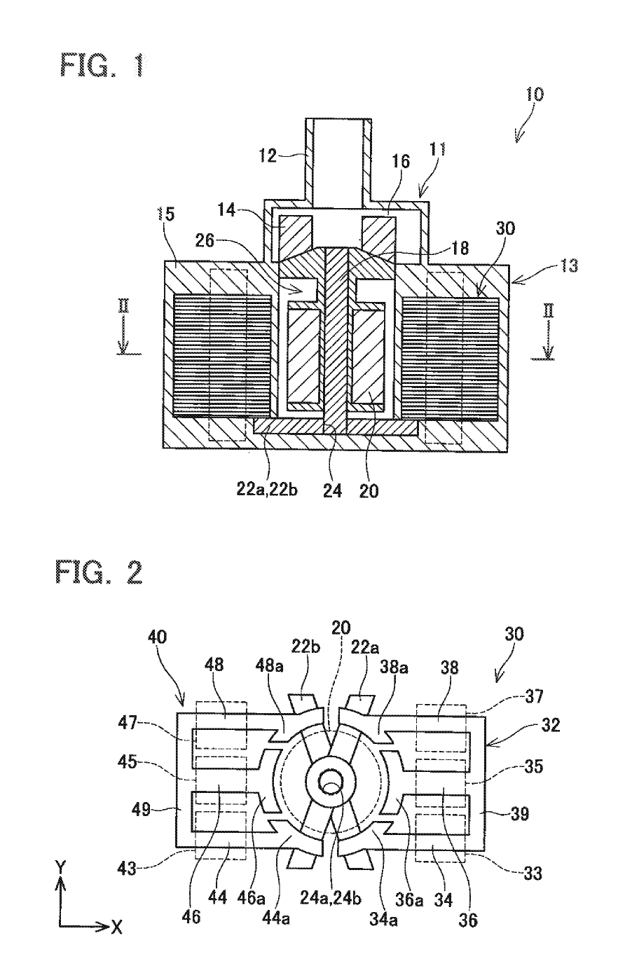

An electric pump 10 according to a first embodiment is installed in an engine room of an automobile and is used to circulate cooling water for cooling an engine, an inverter, and the like. As shown in FIG. 1, the electric pump 10 comprises a pump portion 11 and a motor portion 13.

The pump portion 11 is formed above a casing 15. The pump portion 11 comprises a pump chamber 16. An inlet 12 and an outlet (not shown) formed in the casing 15 are connected to the pump chamber 16. The inlet 12 is connected to an upper end of the pump chamber 16. The outlet is connected to an outside surface of the pump chamber 16. An impeller 14 of a rotating body 26 is disposed in the pump chamber 16.

The motor portion 13 is disposed below the pump portion 11. The motor portion 13 comprises a rotating shaft 18, the rotating body 26, and a stator 30. A lower end of the rotating shaft 18 is rotatably supported by connecting members 22a and 22b which will be described in detail later. The rotating shaft 18 extends vertically in the casing 15 and a tip end of the rotating shaft 18 reaches inside the pump chamber 16. The rotating body 26 is integrally molded on the rotating shaft 18. The rotating body 26 comprises the impeller 14 and a rotor portion 20. A plurality of blades is formed at regular intervals on an upper surface of the impeller 14. The rotor portion 20 having a tubular shape is provided below the impeller 14. The rotor portion 20 is formed of a magnetic material and is magnetized so as to have a plurality of magnetic poles (in the present embodiment, four magnetic poles) in a circumferential direction. The impeller 14 and the rotor portion 20 are integrally connected. Therefore, when the rotating shaft 18 rotates, the rotor portion 20 and the impeller 14 rotate as well.

The stator 30 is disposed outside the rotor portion 20 and opposes the rotor portion 20. The stator 30 is formed by laminating a plurality of magnetic steel sheets on one another. The stator 30 is embedded in the casing 15 and is surrounded by a resin material (in other words, a material of the casing 15).

As shown in FIG. 2, the stator 30 comprises a pair of cores 32 and 40. The cores 32 and 40 comprise yokes 39 and 49 and three teeth (34, 36, and 38) and (44, 46, and 48). Coils (33, 35, and 37) and (43, 45, and 47) are wound around the teeth (34, 36, and 38) and (44, 46, and 48). The coils (33, 35, and 37) and (43, 45, and 47) are connected to a motor drive circuit (not shown).

The yokes 39 and 49 extend in a y axis direction shown in FIG. 2. The yokes 39 and 49 are symmetrically disposed with the rotor portion 20 in between. In other words, the yokes 39 and 49 oppose the rotor portion 20 and the rotor portion 20 is located between the yokes 39 and 49. The three teeth (34, 36, and 38) and (44, 46, and 48) are provided on the yokes 39 and 49.

While base ends of the teeth 34, 36, and 38 are connected to the yoke 39, tip ends 34a, 36a, and 38a of the teeth 34, 36, and 38 oppose the outside surface of the rotor portion 20 with an interval in between. The tip ends 34a, 36a, and 38a of the teeth 34, 36, and 38 are formed in a shape conforming to an outside shape of the rotor portion 20. In the present embodiment, the tooth 34 is a U-phase tooth, the tooth 36 is a V-phase tooth, and the tooth 38 is a W-phase tooth.

The teeth 34, 36, and 38 are disposed parallel to each other and extend in an x direction. Therefore, as shown in FIG. 2, a cross section of the stator 30 (in other words, a cross section perpendicular to a rotational axis line of the rotating shaft 18) has a rectangular shape with long sides that extend in the x direction and short sides that extend in the y direction. In other words, the stator 30 is a flat stator. In addition, as apparent from FIG. 2, the teeth 34 and 38 provided at both ends of the yoke 39 are longer than the tooth 36 provided at center of the yoke 39. Furthermore, while the teeth 34 and 38 provided at both ends of the yoke 39 are inclined with respect to a radial direction of the rotor, the tooth 36 provided at the center of the yoke 39 extends in the radial direction of the rotor.

The teeth 44, 46, and 48 are configured the same as the teeth 34, 36, and 38. However, the tooth 44 is a W-phase tooth, the tooth 46 is a V-phase tooth, and the tooth 48 is a U-phase tooth. Therefore, in-phase teeth (34 and 48), (36 and 46), and (38 and 44) are symmetrically disposed with respect to the rotating shaft 18.

As shown in FIG. 2, the tooth 34 (U-phase tooth) provided on one end of the yoke 39 is connected to the tooth 48 (U-phase tooth) provided at another end of the yoke 49 by the connecting member 22b. In addition, the tooth 38 (W-phase tooth) provided on another end of the yoke 39 is connected to the tooth 44 (W-phase tooth) provided at one end of the yoke 49 by the connecting member 22a. Since the teeth 34 and 48 are at symmetrical positions with respect to the rotating shaft 18, a deviation of the teeth 34 and 48 in a radial direction is prevented by the connecting member 22b. In a similar manner, since the teeth 38 and 44 are at symmetrical positions with respect to the rotating shaft 18, a deviation of the teeth 38 and 44 in a radial direction is prevented by the connecting member 22a. The connecting members 22a and 22b are formed of a nonmagnetic member (for example, ceramics or aluminum). As shown in FIG. 1, the connecting members 22a and 22b are disposed on lower surface sides of the cores 32 and 40 and connect the teeth (34 and 48) and (38 and 44) on the lower surface sides of the cores 32 and 40. Supporting portions 24a and 24b are formed at centers of the connecting members 22a and 22b. The supporting portions 24a and 24b rotatably support the lower end of the rotating shaft 18.

Next, operations of the electric pump 10 will be described. When power is supplied to the coils (33, 35, and 37) and (43, 45, and 47) from the motor drive circuit (not shown), the rotor portion 20 rotates around the rotating shaft 18. As a result, the impeller 14 rotates and cooling water is suctioned into the pump chamber 16 via the inlet 12. Pressure of the cooling water suctioned into the pump chamber 16 is increased by the rotation of the impeller 14 and the cooling water is discharged to outside of the casing 15 from an outlet (not shown).

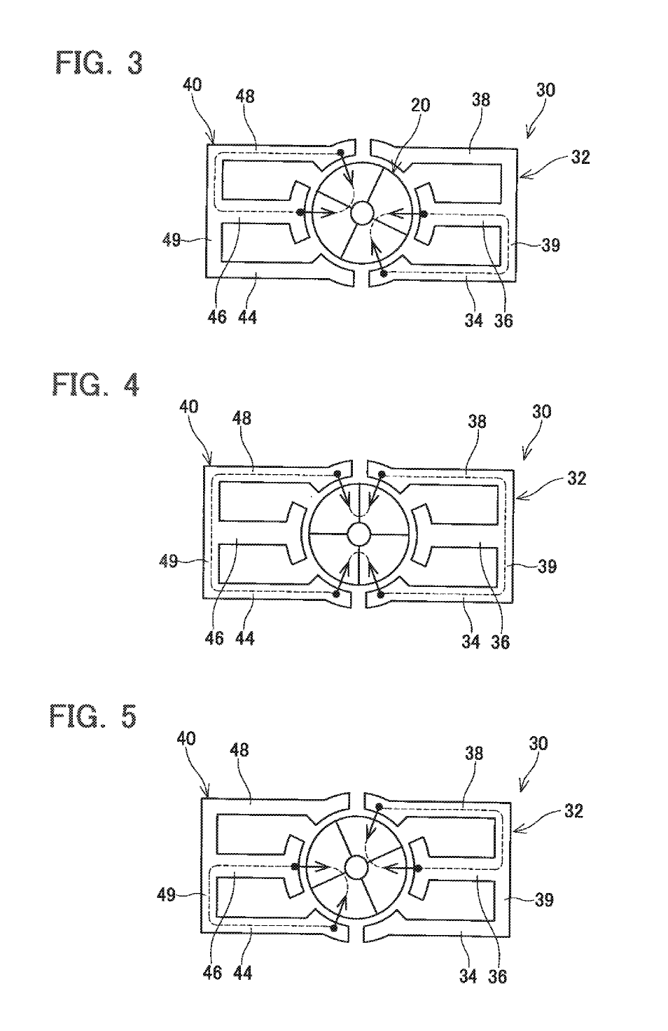

Magnetic attractive force generated between the cores 32, 40 and the rotor portion 20 will now be described. During rotation of the rotor portion 20, the magnetic attractive three generated between the cores 32, 40 and the rotor portion 20 switches among a condition shown in FIG. 3, a condition shown in FIG. 4, and a condition shown in FIG. 5. By sequentially switching among the three conditions, the rotor portion 20 rotates. In the condition shown in FIG. 3, a magnetic flux flows through the teeth 46 and 48, a part of the yoke 49, and the rotor portion 20, a magnetic flux flows through the teeth 34 and 36, a part of the yoke 39, and the rotor portion 20, and magnetic attractive force is generated in a direction indicated by an arrow in FIG. 3. In the condition shown in FIG. 4, a magnetic flux flows through the teeth 44 and 48, the yoke 49, and the rotor portion 20, a magnetic flux flows through the teeth 34 and 38, the yoke 39, and the rotor portion 20, and magnetic attractive force is generated in a direction indicated by an arrow in FIG. 4. In the condition shown in FIG. 5, a magnetic flux flows through the teeth 44 and 46, a part of the yoke 49, and the rotor portion 20, a magnetic flux flows through the teeth 36 and 38, a part of the yoke 39, and the rotor portion 20, and magnetic attractive force is generated in a direction indicated by an arrow in FIG. 5.

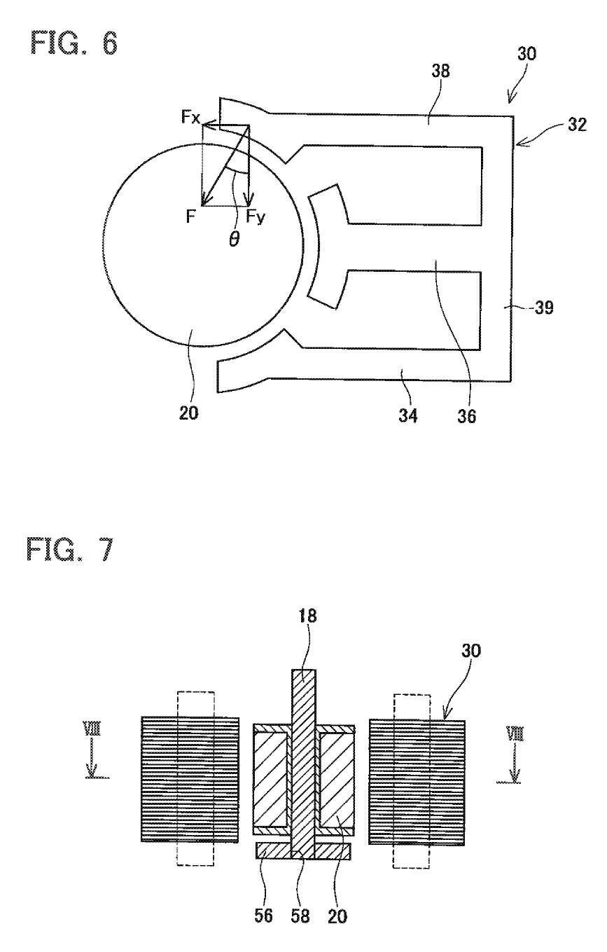

As is apparent from FIGS. 3 to 5, the direction of the magnetic attractive force that acts on the teeth (34 and 38) and (44 and 48) on both ends of the cores 32 and 40 is a direction that causes a bending deformation of the teeth (34 and 38) and (44 and 48). For example, as shown in FIG. 6, magnetic attractive force F that acts between the tooth 38 and the rotor portion 20 is oriented in a direction from the tip end of the tooth 38 toward the rotor portion 20 (a direction approximately consistent with the radial direction of the rotor). Therefore, the magnetic attractive force F has a component Fx in a longitudinal direction of the tooth 38 and a component Fy in a direction perpendicular to the longitudinal direction. In addition, the component Fy generates bending moment on the teeth 38. On the other hand, the direction of the magnetic attractive force that acts on the central teeth 36 and 46 of the cores 32 and 40 is approximately consistent with a longitudinal direction of the teeth 36 and 46. Therefore, the bending moment is hardly generated on the teeth 36 and 46.

In addition, as is apparent from FIGS. 3 to 5, when the magnetic attractive force acts between the tooth 34 (U-phase tooth) of the core 32 and the rotor portion 20, magnetic attractive force acts between the tooth 48 (U-phase tooth) of the core 40 and the rotor portion 20. In a similar manner, when the magnetic attractive force acts between the tooth 36 (V-phase tooth) of the core 32 and the rotor portion 20, magnetic attractive force acts between the tooth 46 (V-phase tooth) of the core 40 and the rotor portion 20, and when the magnetic attractive force acts between the tooth 38 (W-phase tooth) of the core 32 and the rotor portion 20, magnetic attractive force acts between the tooth 44 (W-phase tooth) of the core 40 and the rotor portion 20. In other words, the magnetic attractive forces act simultaneously on the in-phase teeth (34 and 48), (36 and 46), and (38 and 44).

Since the tooth 34 (U-phase tooth) and the tooth 48 (U-phase tooth) are connected by the connecting member 22b, the magnetic attractive force acting on the tooth 34 and the magnetic attractive force acting on the tooth 48 cancel out each other. In addition, the deviation of the teeth 34 and 48 in the radial direction is suppressed by the connecting member 22b. in a similar manner, since the tooth 38 (W-phase tooth) and the tooth 44 (W-phase tooth) are connected by the connecting member 22a, the magnetic attractive force acting on the tooth 38 and the magnetic attractive force acting on the tooth 44 cancel out each other. Furthermore, the deviation of the teeth 38 and 44 in the radial direction is suppressed by the connecting member 22a. Accordingly, bending vibration of the teeth 34, 38, 44, and 48 provided at both ends of the cores 32 and 40 is suppressed. Moreover, while the teeth 36 and 46 are not connected to each other by a connecting member, as described earlier, the direction of the magnetic attractive force that acts on the teeth 36 and 46 is approximately consistent with the longitudinal direction of the teeth 36 and 46. Therefore, the bending moment is hardly generated by the magnetic attractive force and, therefore, the bending vibration hardly occurs on the teeth 36 and 46.

As described earlier, in the present embodiment, since the teeth (34 and 38) and the teeth (48 and 44) are connected to each other by the connecting members 22b and 22a, the bending vibration of the teeth 34, 38, 44, and 48 is suppressed. As a result, motor efficiency can be improved and pump efficiency of the electric pump 10 can be improved. In addition, since vibration of the motor can be suppressed, a variation in a discharge rate of the electric pump 10 can also be suppressed.

Furthermore, in the electric pump 10 according to the present embodiment, the lower end of the rotating shaft 18 is supported by the supporting portions 24a and 24b of the connecting members 22a and 22b. Therefore, a bearing or the like for supporting the lower end of the rotating shaft 18 need not be separately provided. In addition, the teeth (34 and 38) and (44 and 48) of the cores 32 and 40 are positioned with respect to the rotating shaft 18 by providing the connecting members 22a and 22b with the supporting portions 24a and 24b. In other words, the cores 32 and 40 are positioned with respect to the rotating shaft 18. Therefore, since the cores 32 and 40 are disposed at appropriate positions with respect to the rotating shaft 18, a pulsation of a torque acting on the rotor portion 20 or vibration of the rotor portion 20 can be effectively suppressed.

### Second Embodiment

An electric pump according to a second embodiment will be described. The electric pump according to the second embodiment only differs from the electric pump 10 according to the first embodiment in a configuration of a connecting member that connects the teeth 34 and 38 of the core 32 to the teeth 44 and 48 of the core 40. Otherwise, the electric pump according to the second embodiment shares a same configuration as the electric pump 10 according to the first embodiment. Therefore, only portions that differ from the first embodiment will be described below.

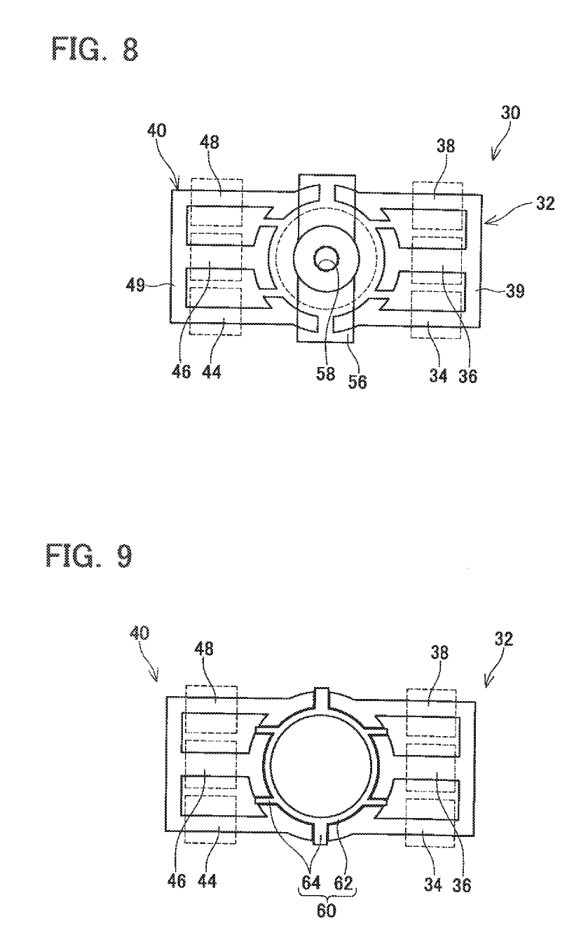

As shown in FIGS. 7 and 8, a connecting member 56 is a plate-like member having a rectangular shape in plan view. The connecting member 56 is disposed on lower surface sides of the cores 32 and 40 and is respectively connected to the teeth 34 and 38 and the teeth 44 and 38 on the lower surface sides of the cores 32 and 40. In addition, a supporting portion 58 is formed at center of the connecting member 56 and rotatably supports the rotating shaft 18.

In the electric pump according to the second embodiment, in addition to the in-phase teeth (34 and 48) and (38 and 44) of the cores 32 and 40 being connected to each other, opposing teeth (34 and 44) and (38 and 48) located at both ends of the cores 32 and 40 are also connected to each other by the connecting member 56. Therefore, relative displacements of the teeth 34, 38, 44, and 48 are prevented and vibration of the teeth 34, 38, 44, and 48 can be further suppressed.

Moreover, while the teeth 36 and 46 located at centers of the cores 32 and 40 are not connected to one another by a connecting member in the embodiments described above, the teeth 36 and 46 may further be connected by a connecting member. For example, a disk-like connecting member may be disposed on lower surface sides of the cores 32 and 40, whereby the teeth 34, 36, and 38 of the core 32 and the teeth 44, 46, and 48 of the core 40 may be connected to the disk-like connecting member. According to such a configuration, since all the teeth 34, 36, 38, 44, 46, and 48 are connected to a single connecting member, vibration of the teeth 34, 36, 38, 44, 46, and 48 can be suppressed more severely.

In addition, while the teeth 34, 38, 44, and 48 are connected on the lower surface sides of the cores 32 and 40 in the embodiments described above, the teeth 34, 38, 44, and 48 may alternatively be connected on upper surface sides of the cores 32 and 40. In this case, a through hole that is penetrated by the rotating shaft 18 may he provided on the connecting member. Furthermore, connecting members may be provided on both upper and lower surfaces of the cores 32 and 40 and the teeth may be connected on both upper and lower surfaces.

Moreover, while the supporting portions (24a and 24b) and 58 are provided on the connecting members (22a and 22b) and 56 in the embodiments described above, supporting portions need not be provided on the connecting members (22a and 22b) and 56 if preventing bending vibration of teeth is a sole objective.

The preferred embodiments of the present teachings have been described above, the explanation was given as examples, and the present teachings is not limited to this type of configuration.

(Modifications) For example, as shown in FIG. 9, the teeth 34, 36, and 38 of the core 32 and the teeth 44, 46, and 48 of the core 40 may be connected to one another by a cylindrical connecting member 60. In other words, the connecting member 60 comprises a cylindrical portion 62 and six protruding portions 64 which protrude from an outer surface of the cylindrical portion 62. The cylindrical portion 62 is inserted inside tip end surfaces of the teeth 34, 36, 38, 44, 46, and 48. Therefore, an inner surface of the cylindrical portion 62 is opposed to the outer surface of the rotor portion 20 with an interval in between. In addition, the protruding portions 64 are inserted between adjacent teeth (34 and 36), (36 and 38), (38 and 48), (48 and 46), (46 and 44), and (44 and 34). Relative displacement between the adjacent teeth (34 and 36), (36 and 38), (38 and 48), (48 and 46), (46 and 44), and (44 and 34) is suppressed due to the protruding portions 64. Even using the connecting member 60 shown in FIG. 9, relative displacement and bending vibration of the teeth 34, 36, 38, 44, 46, and 48 can be suppressed.

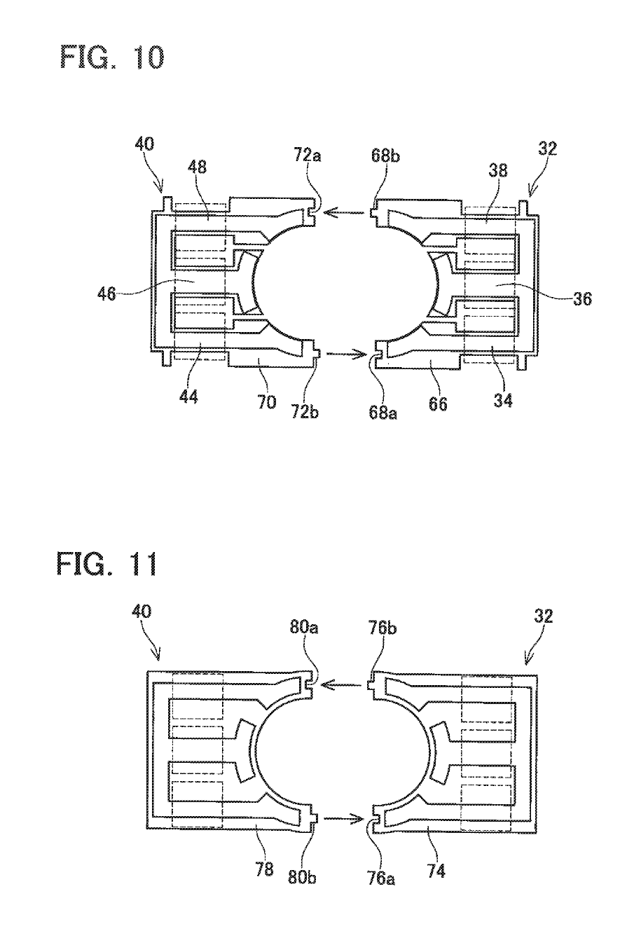

In addition, by forming an engaging portion on a molded resin that covers the cores 32 and 40, assembly accuracy of the core 32 and the core 40 may be improved. For example, as shown in FIG. 10, engaging portions (68a and 68b) and (72a and 72b) may be formed on primary molded resins (so-called bobbins) 66 and 70 of the cores 32 and 40, whereby the core 32 and the core 40 may be assembled using the engaging portions (68a and 68b) and (72a and 72b). In other words, among the primary molded resin 66 of the core 32, a concave engaging portion 68a is formed in a portion that covers a tip end of the tooth 34 and a convex engaging portion 68b is formed in a portion that covers a tip end of the tooth 38. On the other hand, among the primary molded resin 70 of the core 40, a convex engaging portion 72b is formed in a portion that covers a tip end of the tooth 44 and a concave engaging portion 72a is formed in a portion that covers a tip end of the tooth 48. In addition, the core 40 may be assembled to the core 32 by engaging the convex engaging portion 72b of the primary molded resin 70 with the concave engaging portion 68a of the primary molded resin 66 and engaging the concave engaging portion 72a of the primary molded resin 70 with the convex engaging portion 68b of the primary molded resin 66. According to such a configuration, assembly accuracy of the cores 32 and 40 can be improved and generation of torque pulsation and vibration can be effectively suppressed. Furthermore, since opposing teeth (34 and 44) and (38 and 48) are connected to one another, relative displacement among these teeth is suppressed. Accordingly, vibration of the motor can be similarly suppressed. Moreover, since the convex engaging portion 68b and the concave engaging portion 68a are formed on the primary molded resin 66 and the convex engaging portion 72b and the concave engaging portion 72a are formed on the primary molded resin 70, a die for forming the primary molded resin 66 and the primary molded resin 70 can be shared.

While the engaging portions 68a, 68b, 72a, and 72b have been formed on the primary molded resins 66 and 70 in the example shown in FIG. 10, the core 32 and the core 40 may be assembled by forming engaging portions (76a and 76b) and (80a and 80b) on secondary molded resins 74 and 78 for protecting a coil in FIG. 11.

Moreover, portions of a molded resin in which an engaging portion is formed are not limited to portions covering tip ends of the teeth (34 and 38) and (44 and 48). For example, a configuration may be adopted in which engaging portions are further formed on lower surface sides of the cores 32 and 40 and the cores 32 and 40 are connected to each other on the lower surface sides of the cores 32 and 40. Alternatively, a configuration may be adopted in which engaging portions are formed on upper surface sides of the cores 32 and 40 and the cores 32 and 40 are connected to each other on the upper surface sides of the cores 32 and 40.

What is claimed is:

1. A brushless motor comprising:
a rotor; and
a stator disposed outside of the rotor, wherein
the stator comprises a first core and a second core opposing the first core, the rotor being disposed between the first core and the second core,
each of the first core and the second core comprises a U-phase tooth, a V-phase tooth, and a W-phase tooth, each of which is extending parallel to one another and having a tip end opposing the rotor, and
the brushless motor further comprises:
a first nonmagnetic member connecting a tooth located at one end of the first core to a tooth located at the other end of the second core, a phase of the tooth located at the one end of the first core being same as a phase of the tooth located at the other end of the second core, and
a second nonmagnetic member connecting a tooth located at the other end of the first core to a tooth located at one end of the second core, a phase of the tooth located at the other end of the first core being same as a phase of the tooth located at the one end of the second core.

2. The brushless motor as in claim 1, further comprising:
a third nonmagnetic member connecting the tooth located at the one end of the first core to the tooth located at the one end of the second core; and
a forth nonmagnetic member connecting the tooth located at the other end of the first core to the tooth located at the other end of the second core.

3. The brushless motor as in claim 2, wherein
the first nonmagnetic member, the second nonmagnetic member, the third nonmagnetic member, and the forth nonmagnetic member constitute one tubular member,
each of the tip ends of the teeth of the first core and the second core is connected to an outer surface of the tubular member, and
an inner surface of the tubular member opposes the outer surface of the rotor with an interval in between.

4. The brushless motor as in claim 3, wherein
the rotor comprises a rotor shaft,
each of the first nonmagnetic member and the second nonmagnetic member comprises a supporting portion, and
the rotor shaft is rotatably supported by the supporting portions.

5. The brushless motor as in claim 3, wherein
each of the third nonmagnetic member and the fourth nonmagnetic member comprises a first portion provided on the tooth of the first core, and a second portion provided on the tooth of the second core, and
the teeth of the first core are connected to the teeth of the second core by connecting the first portions to the corresponding second portions.

6. The brushless motor as in claim 2, wherein
each of the third nonmagnetic member and the fourth nonmagnetic member comprises a first portion provided on the tooth of the first core, and a second portion provided on the tooth of the second core, and
the teeth of the first core are connected to the teeth of the second core by connecting first portions to the corresponding second portions.

7. The brushless motor as in claim 1, wherein
the rotor comprises a rotor shaft,
each of the first nonmagnetic member and the second nonmagnetic member comprises a supporting portion, and
the rotor shaft is rotatably supported by the supporting portions.

8. An electric pump comprising:
a brushless motor as in claim 1;
an impeller driven by the brushless motor; and
a pump chamber accommodating the impeller, the impeller being capable of rotating in the pump chamber.
